(19) United States
(12) Patent Application Publication
(10) Pub. No.: US 2014/0320781 A1
(43) Pub. Date: Oct. 30, 2014

(54) LIGHT SOURCE UNIT AND DISPLAY DEVICE INCLUDING THE SAME

(71) Applicant: Samsung Electronics Co., Ltd., Suwon-Si (KR)

(72) Inventors: Hun Yong PARK, Seoul (KR); Won Soo JI, Hwaseong-si (KR)

(73) Assignee: SAMSUNG ELECTRONICS CO., LTD., Suwon-Si (KR)

(21) Appl. No.: 14/245,123

(22) Filed: Apr. 4, 2014

(30) Foreign Application Priority Data
Apr. 30, 2013 (KR) 10-2013-0048440

(51) Int. Cl. F21K 99/00; G02F 1/1335

(52) U.S. Cl. CPC F21K 9/50; G02F 1/133603
USPC 349/61; 362/311.01; 362/311.02

(57) ABSTRACT

A light source unit including a light emitting device emitting light and an optical device including a first surface having an incident surface, through which light from the light emitting device is incident, and a second surface through the incident light is outwardly emitted, wherein the first surface has a recess recessed toward the second surface and forming the incident surface, and the second surface protrudes in a dome shape from an edge of the first surface, the second surface having a concave portion depressed toward a planar portion in a center of the first surface, and the incident surface includes the planar portion at a top portion of the recess and a curved portion, the planar portion and the curved portion forming an opening, the curved portion extending between the planar portion and a portion of the first surface outside the incident surface may be provided.

### CROSS-REFERENCE TO RELATED APPLICATION

This application claims priority under 35 U.S.C. §119 to Korean Patent Application No. 2013-0048440 filed on Apr. 30, 2013, with the Korean Intellectual Property Office, the entire disclosure of which is incorporated herein by reference.

### BACKGROUND

The present disclosure relates to a light source unit and/or a display device including the same.

In general, a backlight device used in a liquid crystal display device employs various fluorescent lamps, for example, cold cathode fluorescent lamps (CCFLs) or external electrode fluorescent lamps (EEFLs) therein. Recently, light emitting diodes have become prominent as light sources in next generation backlight units due to various advantages (e.g., eco-friendliness and relatively long lifespans).

Because light emitting diodes have an orientation angle of about 120°, various forms of lens may be applied thereto in order to implement a wide orientation angle. However, a lens of the related art may diffuse light emitted from a light emitting diode in an excessively lateral manner. Accordingly, a quantity of light emitted upwardly from the light emitting diode may be reduced to generate a difference between light and shade, thereby failing to supply an uniform surface illumination.

### SUMMARY

Some example embodiments of the present disclosure may provide a light source unit having an improved luminance uniformity while implementing a wide orientation angle, and a display device including the same.

Example embodiments of the present disclosure are not limited thereto. Although not specifically described, objects and effects understandable from the summary and the example embodiments to be described later would be included therein.

According to an example embodiment of the present disclosure, alight source unit may include a light emitting device emitting light, and an optical device including a first surface having an incident surface and a second surface, the incident surface being a surface through which light from the light emitting device is incident, and the second surface being a surface through which the incident light is outwardly emitted, wherein the first surface has a recess recessed toward the second surface and forming the incident surface, and the second surface protrudes in a dome shape from an edge of the first surface, the second surface having a concave portion depressed toward a planar portion in a center of the first surface, and the incident surface includes the planar portion at a top portion of the recess and a curved portion, the planar portion and the curved portion forming an opening, the curved portion extending between the planar portion and a portion of the first surface outside the incident surface.

The planar portion may intersect with the curved portion at a point at which the light emitted from the light emitting device forms an angle of 10° with respect to an optical axis of the light emitting device.

A shape of the incident surface may be configured to satisfy that a length R increases in accordance with an increase in angle (θ) within a range of θ≦10°, and decreases in accordance with the increase in angle (θ) within a range of θ>10°, where, when an intersection between an optical axis and a light emitting surface of the light emitting device is defined as a reference point O, the length R indicates a straight line connecting the reference point O and an optical point of the incident surface, and the angle (θ) indicates an angle formed by the straight line R and the optical axis.

A shape of the second surface may be configured to satisfy that a value of θ₂/θ₁ increases in accordance with an increase in a first angle θ₁ within a range of below about 10° with respect to an optical axis of the light emitting device, and decreases in accordance with the increase in the first angle θ₁ within a range of equal to or greater than 10° with respect to the optical axis of the light emitting device, where the first angle θ₁ indicates an emission angle of light emitted from the light emitting device, and a second angle θ₂ indicates an angle at which the incident light emits outwardly from the second surface.

A portion of the first surface outside the opening may have a curved surface protruding toward the light emitting device.

The first surface may further have a coupling groove formed therein and configured to the light emitting device therein.

The planar portion may be provided with a Fresnel pattern.

The optical device may be provided in plural and the plurality of optical devices may be arranged in columns and rows to form a single integrated structure.

The light emitting device may include a light emitting diode chip and a body part having the light emitting diode chip on an inner portion thereof.

According to an example embodiment of the present disclosure, a display device may include a plurality of light source units, each of the plurality of light source units being the light source unit as described hereinabove, a housing having the plurality of light source units mounted thereon, and a liquid crystal display disposed above the plurality of light source units and receiving light emitted from the plurality of light source units.

According to an example embodiment of the present disclosure, q light source structure may include a light emitting device configured to emit light, and an optical device on the light emitting device and configured to irradiate the emitted light by adjusting an orientation angle thereof. The optical device may include a first surface facing the light emitting device and including a recessed portion, the recessed portion having a symmetrical structure with respect to an optical axis passing through a center of the optical device and having a flat top surface, a top portion of the recess being a planar portion, a second surface opposite to the first surface and having a concave portion, the concave portion having a symmetrical structure with respect to the optical axis, and the recess recessed toward the second surface and the concave portion depressed toward the planar portion of the recess.

The recess may further include a curved side surface, the curved side portion intersects with the planar portion at a point, and an angle formed by the optical axis and a straight line is about 10°, where the straight line is a line of the emitted light drawn to the point.

The second surface may be configured to increase a value of θ2/θ1 in accordance with an increase in a first angle θ1 within a range of less than 10° and decrease the value of θ2/θ1 in accordance with an increase in the first angle θ1 within a range of about equal to or greater than 10°, where a first angle θ1 indicates an angle of the emitted light with respect to the optical axis and a second angle θ2 indicates an angle at which the emitted light is outwardly irradiated from the second surface.

The second surface may protrude in a dome shape from an edge of the first surface.

The first surface may have a curved surface downwardly protruding toward the light emitting device.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a light source unit according to an example embodiment of the present disclosure;

FIG. 2 is a cross-sectional view of the light source unit of FIG. 1;

FIG. 3 is a cross-sectional view schematically illustrating a light emitting device in the light source unit of FIG. 1;

FIG. 4 is an enlarged cross-sectional view schematically illustrating an incident surface of an optical device in the light source unit of FIG. 1;

FIG. 5 is a cross-sectional view schematically illustrating a structure of the optical device in the light source unit of FIG. 1;

FIGS. 6A and 6B are graphs illustrating a relationship between θ2/θ1 and θ1;

FIG. 7 is a graph illustrating intensity distribution of light;

FIG. 8 is a cross-sectional view schematically illustrating a light source unit according to another example embodiment of the present disclosure;

FIGS. 9A, 9B, 10A and 10B are cross-sectional views each schematically illustrating a light source unit according to various example embodiments of the present disclosure;

FIG. 11 is a cross-sectional view schematically illustrating a display device according to an example embodiment of the present disclosure;

FIGS. 12A and 12B are plan views each schematically illustrating a state in which the optical device of FIG. 11 is arranged; and

FIG. 13 is a perspective view schematically illustrating a lighting device according to an example embodiment of the present disclosure.

### DETAILED DESCRIPTION

Various example embodiments of the present disclosure will now be described in detail with reference to the accompanying drawings.

The present disclosure may, however, be embodied in many different forms and should not be construed as being limited to the specific example embodiments set forth herein. Rather, these example embodiments are provided so that this disclosure will be thorough and complete, and will fully convey the scope of the disclosure to those skilled in the art.

In the drawings, the shapes and relative dimensions of elements may be exaggerated for clarity, and the same or like reference numerals will be used throughout to designate the same or like elements.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term. “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “lower,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, some example embodiments will be explained in further detail with reference to the accompanying drawings.

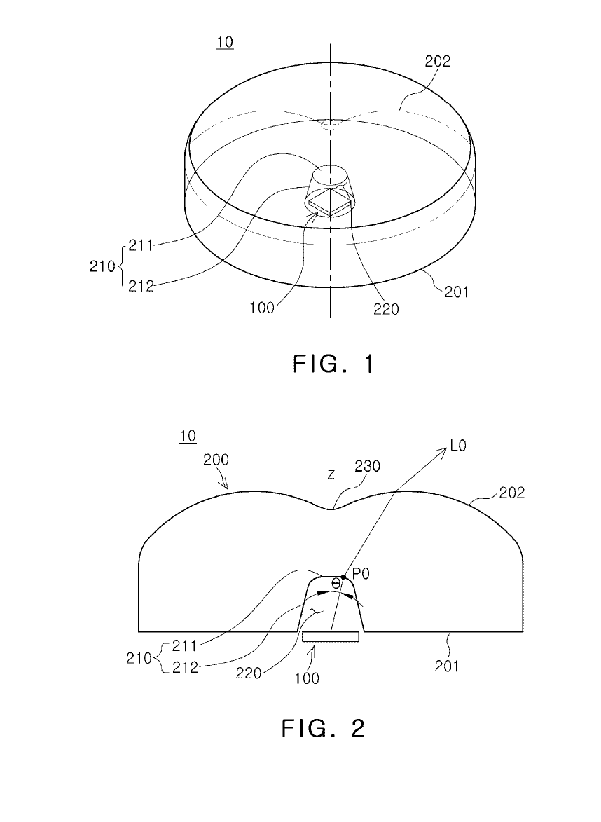

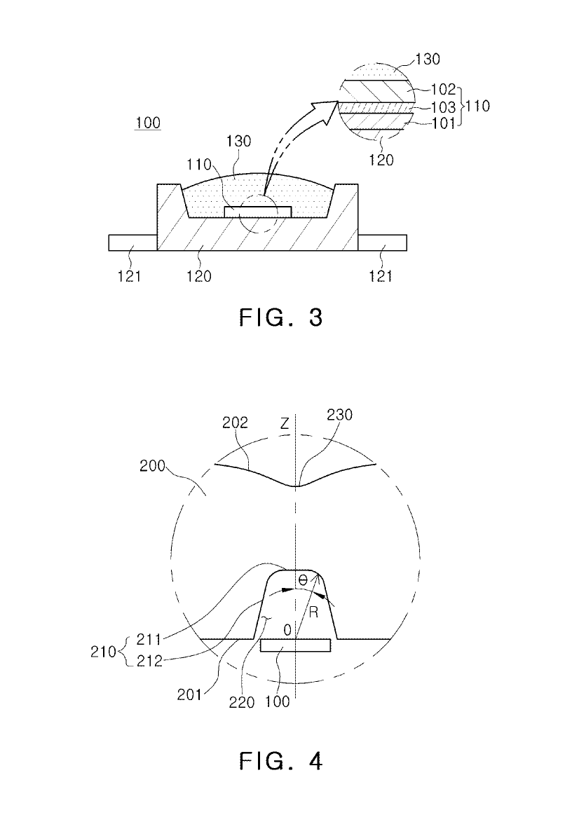

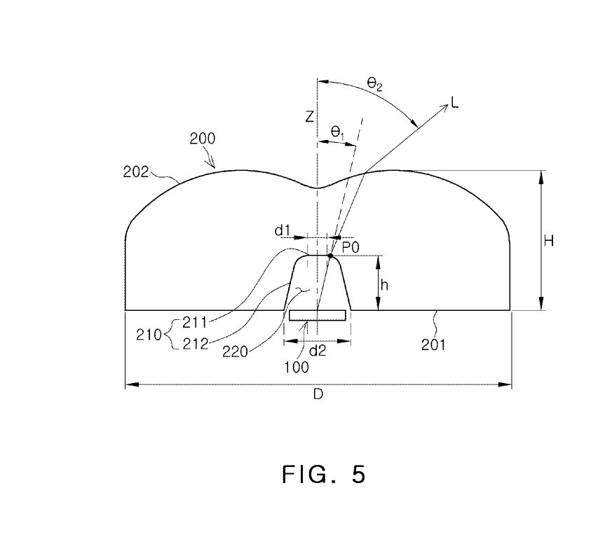

A light source unit according to an example embodiment of the present disclosure will be described with reference to FIGS. 1 through 5. FIG. 1 is a perspective view schematically illustrating alight source unit according to an example embodiment of the present disclosure. FIG. 2 is a cross-sectional view of the light source unit of FIG. 1. FIG. 3 is a cross-sectional view schematically illustrating a light emitting device in the light source unit of FIG. 1. FIG. 4 is an enlarged cross-sectional view schematically illustrating an incident surface of an optical device in the light source unit of FIG. 1. FIG. 5 is a cross-sectional view schematically illustrating a structure of the optical device in the light source unit of FIG. 1.

As illustrated in FIGS. 1 and 2, a light source unit 10 according to an example embodiment of the present disclosure may include a light emitting device 100 emitting light and an optical device 200 disposed above the light emitting device 100.

As the light emitting device 100, any photoelectric device may be used as long as it generates light having a desired (or alternatively, predetermined) wavelength based on an external power applied thereto. For example, the light emitting device 100 may be a semiconductor light emitting diode (LED) formed by epitaxially-growing a semiconductor layer on a growth substrate. The light emitting device 100 may emit red light, green light, or blue light depending on a material contained therein. The light emitting device 100 may also emit white light.

For example, as illustrated in FIG. 3, the light emitting device 100 may have a stacked structure of an n-type semiconductor layer 101 and a p-type semiconductor layer 102, and an active layer 103 interposed therebetween. However, the structure of the light emitting device 100 is not limited to the shape illustrated in FIG. 3. For example, the active layer 103 may be configured of a nitride semiconductor having a single or multi-quantum well structure and including a composition of InₓAl_{y}Ga_{1-x-y}N (0≦x≦1, 0≦y≦1, 0≦x+y≦1).

The light emitting device 100 may have a package structure including a light emitting diode chip 110 having the stacked structure and a body part 120 having the light emitting diode chip 110 on an inner portion thereof. The body part 120 may be a base member on which the light emitting diode chip 110 is mounted and supported thereby. The body part 120 may be formed of a white molding compound having a high degree of light reflectance so that a quantity of externally discharged light, which is emitted from the light emitting diode chip 110 and reflected, is increased. The white molding compound may include a highly heat resistant thermosetting resin or silicon resin. The white molding compound may include a thermoplastic resin with, for example a white pigment, filler, a hardening agent, a release agent, an antioxidant, and/or an adhesion improver. For example, the white molding compound may be formed of FR-4, CEM-3, an epoxy material, a ceramic material, or a metal (e.g., aluminum (Al)).

The body part 120 may include a lead frame 121 for electrical connection with an external power supply. The lead frame 121 may be formed of a material having excellent electrical conductivity, for example, a metal material (e.g., aluminum or copper). In the case that the body part 120 is formed of the metal material, an insulating material may be interposed between the body part 120 and the lead frame 121.

Further, the light emitting diode chip 110 may be encapsulated by an encapsulant 130 formed on the body part 120.

In the example embodiment, the light emitting device 100 is illustrated as a single package configured of the body part 120 having the light emitting diode chip 110 on the inner portion thereof. However, the light emitting device 100 is not limited to the example described above. For example, the light emitting device 100 may be the light emitting diode chip 110 itself.

The optical device 200 may be disposed above the light emitting device 100 and adjust an orientation angle of light emitted and irradiated outwardly from the light emitting device 100. The optical device 200 may include a lens for implementing an wide orientation angle by diffusing the light.

In the specification, the terms ‘above’, ‘upper portion’, ‘upper surface’, ‘below’ lower portion′, ‘lower surface’ and the like are used with respect to the drawings, and may be interpreted to be different (e.g., opposite) depending on a direction in which the optical device 200 is disposed.

The optical device 200 may be formed of a light penetrable (e.g., transparent to light) resin material, for example, polycarbonate (PC), polymethyl methacrylate (PMMA), or an acrylic material. Further, the optical device 200 may be formed of a glass material, but is not limited thereto.

The optical device 200 may be formed by method of injecting a liquid solvent into a mold, in which the liquid solvent is to be solidified. For example, the methods may include, for example, an injection molding method, a transfer molding method, or a compression molding method.

The optical device 200 may contain a light dispersion material in a range of about 3% to 15%. The light dispersion material may include at least one selected from the group consisting of SiO₂, TiO₂ and Al₂O₃. In the case where the light dispersion material is included in an amount of less than 3%, light may not be sufficiently dispersed, and thus desired light dispersion effects may not be achieved. In the case where the light dispersion material is included in an amount of more than 15%, a quantity of light emitted outwardly through the optical device 200 may be reduced, thereby degrading light extraction efficiency.

The optical device 200 may have a first surface 201 including an incident surface 210 through which light from the light emitting device 100 is incident and a second surface 202 outwardly emitting light incident through the incident surface 210.

The first surface 201, a surface facing the light emitting device 100, may be a bottom surface of the optical device 200 and may have a flat circular shape. A recess 220, which is recessed toward the second surface 202, may be formed in the center of the first surface 201.

The recess 220 may have a symmetrical structure with respect to an optical axis Z passing through the center of the optical device 200, and a surface thereof may be defined as the incident surface 210 through which light from the light emitting device 100 is incident. As illustrated in the drawings, the recess 220 may be disposed to face the light emitting device 100 while covering the light emitting device 100, and light generated from the light emitting device 100 may be introduced into the optical device 200 through the incident surface 210. The recess 220 may be filled with air, for example.

The incident surface 210 may be configured to include a planar portion 211 forming a top portion of the recess 220 and a curved portion 212 extended downwardly from the planar portion 211 to the first surface 201 and forming an opening of the first surface 201 having the flat circular shape. The recess 220 may be exposed outwardly through the opening in the first surface 201.

The planar portion 211 may be a circular region perpendicular to the optical axis Z and having a desired (or alternatively, predetermined) size, and an edge of the planar portion 211 may be connected to the curved portion 212 at a point P0, at which the planar portion 211 intersects with light L0 emitted from the light emitting device 100 at an angle (θ) of, for example, about 10° with respect to the optical axis Z of the light emitting device 100. The planar portion 211 may have an area having a radius defined by a horizontal distance from the optical axis Z to the point P0. The point P0 at which the planar portion 211 and the curved portion 212 intersect with each other may be understood as an inflection point.

As illustrated in FIG. 4, a shape of the incident surface 210 including the planar portion 211 and the curved portion 212 may be formed to satisfy the following conditions 1 and 2,

Condition 1: a length R increases in accordance with an increase in angle (fa within a range of rdance, and

Condition 2: the length R decreases in accordance with the increase in angle (θ) within a range of θ>10°,

where when an intersection between the optical axis Z and a light emitting surface of the light emitting device is defined as a reference point O, R indicates a straight line connecting the reference point O and an optical point on the incident surface, and angle (θ) indicates an angle formed by the straight line R and the optical axis Z.

For example, the length R may increase in accordance with an increase in angle (θ) within a range of about ±10°, but may decrease in accordance with the increase in angle (θ) outside of the angle range.

The planar portion 211 may be provided with a Fresnel pattern having unevenness. The Fresnel pattern may be formed in the planar portion 211 in an embossing or engraving manner.

The second surface 202, a light emitting surface from which light introduced into the optical device 200 through the incident surface 210 emits outwardly, may be a top surface of the optical device 200 and may protrude upwardly in a dome shape from the first surface 201, while having a concave portion 230 depressed toward the planar portion 211 in the center thereof.

As illustrated in FIG. 5, a shape of the second surface 202 may be formed to satisfy the following conditions 3 and 4,

Condition 3: a value of θ₂/θ₁ increases in accordance with an increase in angle θ₁ within a range of an angle of about below 10° with respect to the optical axis Z of the light emitting device 100, and

Condition 4: the value of θ₂/θ₁ decreases in accordance with the increase in angle θ₁ within a range of an angle of about equal to or greater than 10° with respect to the optical axis Z of the light emitting device 100,

where angle θ₁ indicates an emission angle of light emitted from the light emitting device 100, and angle θ₂ indicates an angle at which light having the emission angle emits outwardly from the second surface 202.

The optical device according to the example embodiment satisfying the conditions 1 to 4 may be compared with an optical device according to a comparative example.

The optical device according to the example embodiment may be set to have D=15.5 mm, H=4.125 mm, d1=1 mm, d2=3 mm, and h=2.8 mm. The optical device according to the comparative example may be set to have D=15.5 mm, H=4.346 mm, and d2=3 mm and have a structure having no d1 (e.g., a conical shell shape defining a recess meaning without having a planar portion at a top portion of an incident surface of the optical device). Thus, the comparative example is irrelevant to the conditions 1 to 4 and the length R decreases in accordance with the increase in angle (θ) with respect to the length R in the case of θ=0°.

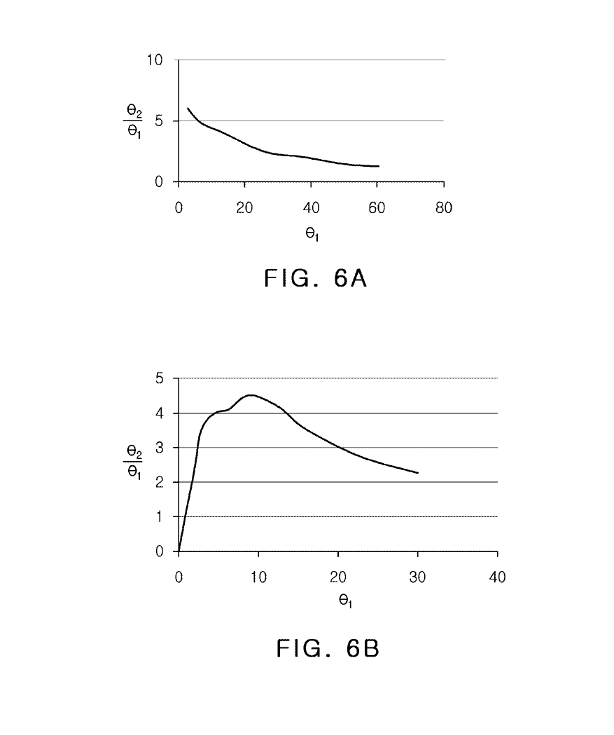

FIG. 6 is graphs illustrating a relationship between θ₂/θ₁ and θ₁. As illustrated in FIG. 6A, the comparative example shows that the value of θ₂/θ₁ continuously decreases in accordance with the increase in angle θ₁. On the other hand, as illustrated in FIG. 6B, the example embodiment shows that the value of θ₂/θ₁ increases in accordance with the increase in angle θ₁ within a range of below about 10°, while the value of θ₂/θ₁ decreases in accordance with the increase in angle θ₁ within a range of equal to or greater than about 10°

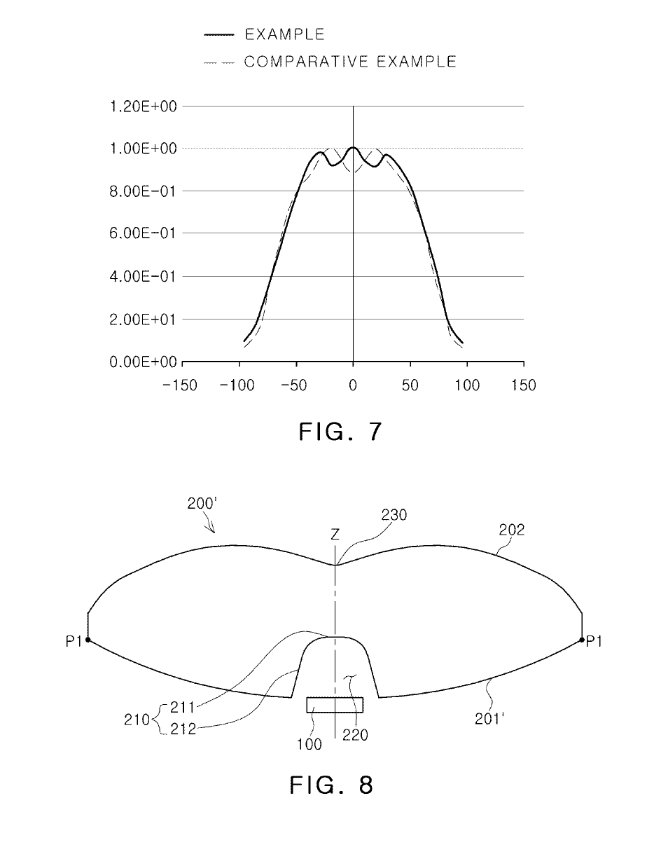

FIG. 7 illustrates intensity distribution of light. FIG. 7 confirms that in a region adjacent to the optical axis Z (i.e., the center of the optical device) the intensity of light decreases in the comparative example, while the intensity of light increases in the example embodiment.

Thus, in the case of a lens according to the comparative example implementing a wide orientation angle, light may be excessively laterally diffused, and thus a quantity of light is relatively reduced in an optical axis portion. Accordingly, luminance may not be uniform. However, according to the example embodiment, a quantity of light may not be reduced in the optical axis portion. Accordingly, a degree of uniformity in luminance may be improved. This is because a degree to which light is refracted by the planar portion 211 in the optical axis Z portion according to the example embodiment is relatively smaller than that of the conical structure according to the comparative example.

Uneven structures defining surface roughness may be formed on at least one of the first surface 201 and the second surface 202. The uneven structures may have a relatively fine size of approximately 25 to 300 μm. The uneven structures may be formed on the incident surface 210 of the first surface 201, or on the entirety of the second surface 202 including the concave portion 230 to thereby improve light uniformity through diffused reflection of light.

The uneven structures may be formed by using, for example, sanding processing or chemical etching processing.

FIG. 8 schematically illustrates a light source unit according to another example embodiment of the present disclosure. Basic constitution of the light source unit according to the example embodiment of FIG. 8 are substantially identical to that of the example embodiment illustrated in FIGS. 1 to 5; Therefore, a description with regard to overlapping features will be omitted or briefly explained and a configuration specific to the optical device illustrated in FIG. 8 will be mainly explained.

As illustrated in FIG. 8, an optical device 200′ may have a first surface 201′ including the incident surface 210 through which light from the light emitting device 100 is incident and the second surface 202 outwardly emitting light incident through the incident surface 210.

The first surface 201′ facing the light emitting device 100, may have a curved surface downwardly protruding toward the light emitting device 100. Further, the recess 220 may be formed in the center of the first surface 201′, the recess 220 being recessed toward the second surface 202. Different from the foregoing example embodiment of FIG. 1 in which the first surface has a flat shape, the first surface 201′ according to the present example embodiment has a gently curved surface (e.g., a dome shape). For example, a portion of the first surface 201′ between the opening exposing the recess 220 and an edge of the first surface 201′ connected to the second surface 202 may have a curved surface protruding toward the light emitting device 100.

Points P1 connecting the first surface 201′ and the second surface 202 may correspond to an edge portion of the optical device 200′ defining a diameter thereof, and may be disposed on the same horizontal level as the planar portion 211. For example, a straight line connecting the points P1 may be overlapped with the planar portion 211.

The second surface 202, a light emitting surface from which light introduced into the optical device 200′ through the incident surface 210 of the recess 220 emits outwardly, may be a top surface of the optical device 200′ and may protrude in a dome shape from the edge of the first surface 201′, while having the concave portion 230 depressed toward the planar portion 211 in the center thereof.

Because the structure of the second surface 202 and the conditions 3 and 4 on the shape of the second surface 202 are substantially identical to those of the example embodiment of FIG. 1, a detailed description thereof will be omitted with regard to the present example embodiment.

Accordingly, the first surface 201′ may have a symmetrical structure with respect to the optical axis Z and have a protruding curved surface (e.g., a dome shape) so that the first surface 201′ may serve as a reflective surface. In general, the majority of light generated from the light emitting device 100 may be outwardly emitted through the optical device 200′, but a portion thereof may be directed in a direction of the first surface 201′ due to reflection thereof. A portion of the reflected light may be re-reflected on the first surface 201′ and emitted outwardly through the second surface 202, thereby compensating the reduction in a quantity of light. Because the first surface 201′ has a protruding curved surface, light may be reflected on the optical axis Z portion of the second surface 202, thereby increasing a quantity of light in the optical axis Z portion.

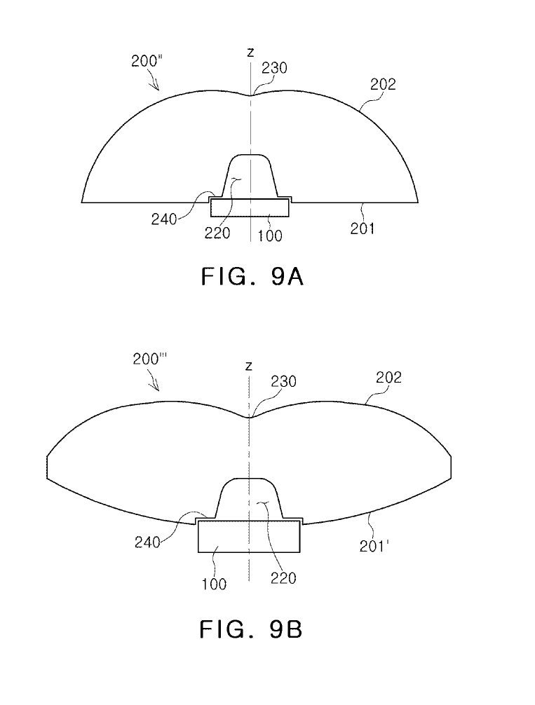

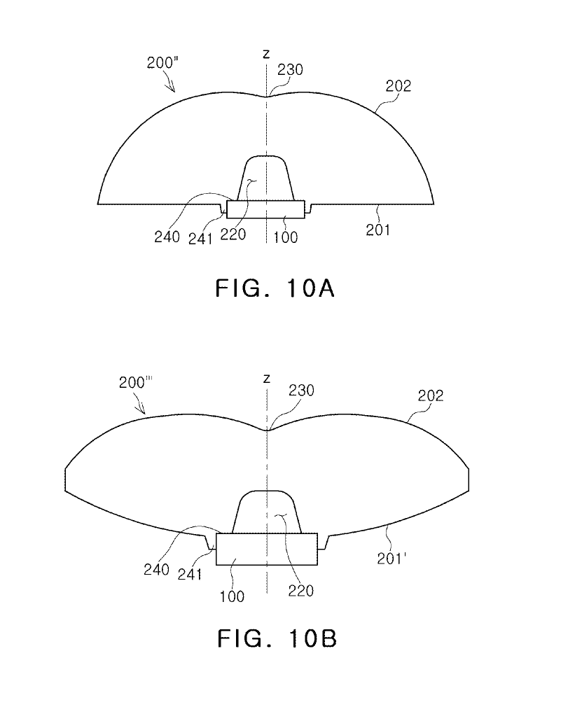

FIGS. 9 and 10, each schematically illustrates a light source unit according to various example embodiments of the present disclosure. Basic constitutions of the light source unit according to respective example embodiments of FIGS. 9 and 10 are substantially identical to those of the foregoing example embodiments illustrated in FIGS. 1 to 8. Therefore, a description with regard to overlapping features will be omitted or briefly explained and a configuration specific to the optical device illustrated in FIGS. 9 and 10 will be mainly explained.

As illustrated in FIGS. 9 and 10, an optical device 200″ or 200′″ may have the first surface 201 or 201′ including the incident surface 210 through which light from the light emitting device 100 is incident and the second surface 202 outwardly emitting light incident through the incident surface 210.

A coupling groove 240 may be provided in the first surface 201 or 201′ facing the light emitting device 100. The coupling groove 240 is configured to receive the light emitting device 100 therein.

As illustrated in FIGS. 9A and 9B, the coupling groove 240 may be formed to be recessed in a stepped manner between the first surface 201 or 201′ and an edge of the opening. The coupling groove 240 may be formed to have a shape corresponding to the light emitting device 100, and in the optical device 200″ or 200′″. The light emitting device 100 may be fitted into the coupling groove 240. The coupling groove 240 may serve to guide a position of the optical device 200″ or 200′″ such that a degree of precision in assembly may be improved during mounting the optical device, and thus a uniform light orientation angle may be secured.

Furthermore, as illustrated in FIGS. 10A and 10B, the coupling groove 240 may be formed in a stepped manner, while having a protrusion portion 241 protruding between the first surface 201 or 201′ and the edge of the opening.

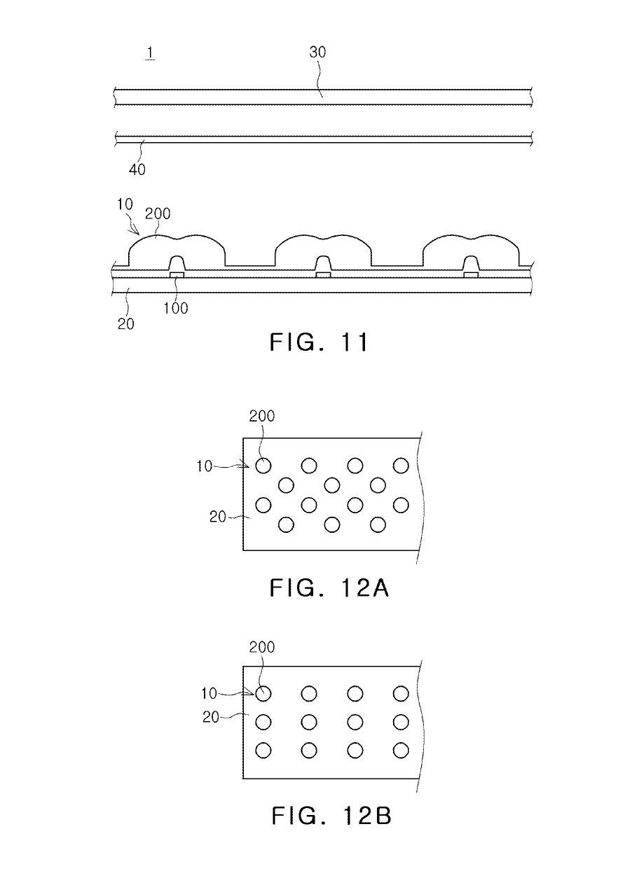

With reference to FIG. 11, a display device according to an example embodiment of the present disclosure will be described. FIG. 11 is a cross-sectional view schematically illustrating a display device according to an example embodiment of the present disclosure.

As illustrated in FIG. 11, a display device 1 according to an example embodiment of the present disclosure may include a plurality of light source units 10, a housing 20 having the plurality of light source units 10 mounted thereon, and a liquid crystal display 30 disposed above the plurality of light source units 10 and receiving light emitted from the plurality of light source units 10.

The plurality of light source units 10 may include the light emitting devices 100 emitting light and the optical devices 200 disposed above the light emitting devices 100. Further, the plurality of light source units 10 may be arranged in various directions (e.g., a first direction and a second direction lying at a right angle to the first direction) on a horizontal plane, in a matrix form, as illustrated in FIGS. 12A and 12B. That is, the plurality of light emitting devices 100 may be spaced apart from one another by a desired (or alternatively, predetermined) interval, and the optical devices 200 may be disposed above the light emitting devices 100 in positions corresponding thereto. For example, the plurality of optical devices 200 may be arranged in columns and rows to form a single integrated structure. For example, the plurality of optical devices 200 may be prepared as individual devices, similarly to the case of the light emitting devices 100 illustrated in FIGS. 1-5 and 8-10, and may be assembled to be disposed above the respective light emitting devices 100.

The display device 1 may further include a substrate (not shown) having the plurality of light source units 10 mounted thereon.

The housing 20 may be a frame member on which the light source units 10 are mounted, and may include a bottom sash configuring a backlight unit, for example. A surface of the housing on which the light source units 10 are mounted may be provided with a circuit wiring electrically connecting the light emitting devices 100 of the light source units 10.

The liquid crystal display 30 may be disposed above the light source units 10 and receive light emitted from the light source units 10. Further, an optical sheet may be further interposed between the liquid crystal display 30 and the light source units 10 in order to further uniformly diffuse and spread light from the light source units 10. The optical sheet may include at least one prism sheet 40.

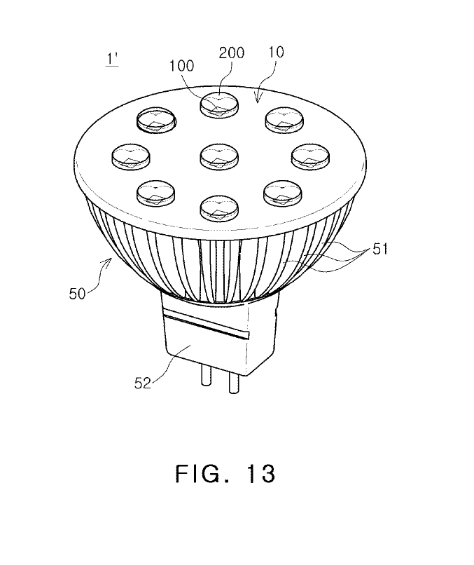

With reference to FIG. 13, a lighting device 1′ according to an example embodiment of the present disclosure will be described. FIG. 13 is a perspective view schematically illustrating a lighting device according to an example embodiment of the present disclosure.

As illustrated in FIG. 13, the lighting device 1′ according to an example embodiment of the present disclosure may include a lamp (e.g., an indoor lamp or a vehicle headlight lamp). The lighting device 1′ according to the example embodiment of the present disclosure may be configured to include a lamp body 50 corresponding to a heat sink and the light source unit 10 mounted on the lamp body 50.

The lamp body 50 may be formed of a material having superior heat radiation efficiency in order to outwardly emit heat generated from the light source unit 10, and a plurality of heat radiating fins 51 may be protruded from a surface thereof. Further, one end of the lamp body 50 may be provided with a terminal part 52 (e.g., socket) connected to an external power source to receive power supplied thereto.

The light source unit 10 may include the plurality of light emitting devices 100 and the plurality of optical device 200 disposed above the light emitting devices 100, and may further include a substrate (not shown) having the light emitting devices 100 mounted thereon.

As set forth above, according to example embodiments of the present disclosure, a light source unit having improved luminance uniformity while implementing a light orientation angle, and a display device including the same may be provided.

While some example embodiments have been shown and described above, it will be apparent to those skilled in the art that modifications and variations could be made without departing from the spirit and scope of the present disclosure as defined by the appended claims.

What is claimed is:

1. A light source unit comprising:
a light emitting device emitting light; and
an optical device including a first surface having an incident surface and a second surface, the incident surface being a surface through which light from the light emitting device is incident, and the second surface being an surface through which the incident light is outwardly emitted,
wherein the first surface has a recess recessed toward the second surface and forming the incident surface, and the second surface protrudes in a dome shape from an edge of the first surface, the second surface having a concave portion depressed toward a planar portion in a center of the first surface, and
the incident surface includes the planar portion at a top portion of the recess and a curved portion, the planar portion and the curved portion forming an opening, the curved portion extending between the planar portion and a portion of the first surface outside the incident surface.

2. The light source unit of claim 1, wherein the planar portion intersects with the curved portion at a point at which the light emitted from the light emitting device forms an angle of 10° with respect to an optical axis of the light emitting device.

3. The light source unit of claim 1, wherein a shape of the incident surface is configured to satisfy that a length R increases in accordance with an increase in angle (θ) within a range of θ≦10°, and decreases in accordance with the increase in angle (θ) within a range of θ>10°,
where when an intersection between an optical axis and a light emitting surface of the light emitting device is defined as a reference point O, the length R indicates a straight line connecting the reference point O and an optical point on the incident surface, and the angle (θ) indicates an angle formed by the straight line R and the optical axis.

4. The light source unit of claim 1, wherein a shape of the second surface is configured to satisfy that a value of θ₂/θ₁ increases in accordance with an increase in a first angle θ₁ within a range of below about 10° with respect to an optical axis of the light emitting device, and decreases in accordance with the increase in the first angle θ₁ within a range of equal to or greater than about 10° with respect to the optical axis,
where the first angle θ₁ indicates an emission angle of light emitted from the light emitting device, and a second angle θ₂ indicates an angle at which the incident light emits outwardly from the second surface.

5. The light source unit of claim 1, wherein a portion of the first surface outside the opening has a curved surface protruding toward the light emitting device.

6. The light source unit of claim 5, wherein points connecting the first surface and the second surface are disposed on a same horizontal level as the planar portion.

7. The light source unit of claim 1, wherein the first surface further includes a coupling groove formed therein, the coupling groove configured to receive the light emitting device therein.

8. The light source unit of claim 1, wherein the planar portion is provided with a Fresnel pattern.

9. The light source unit of claim 1, wherein the optical device further has unevenness structures formed on at least one of the first surface and the second surface.

10. The light source unit of claim 1, wherein the optical device contains a light dispersion material in a range of about 3% to about 15%.

11. The light source unit of claim 1, wherein the recess is filled with air.

12. The light source unit of claim 1, wherein the light emitting device includes a light emitting diode chip and a body part having the light emitting diode chip on an inner portion thereof.

13. A display device comprising:
a plurality of light source units,
a housing having the plurality of light source units mounted thereon, and
a liquid crystal display disposed above the plurality of light source units and receiving light emitted from the plurality of light source units,
wherein each of the plurality of light source units is the light source unit of claim 1.

14. The display device of claim 13, further comprising:
an optical sheet interposed between the liquid crystal display and the plurality of light source units.

15. The display device of claim 13, further comprising:
a substrate having the plurality of light source units mounted thereon.

16. A light source structure comprising:
a light emitting device configured to emit light; and
an optical device on the light emitting device and configured to irradiate the emitted light by adjusting an orientation angle thereof, the optical device including,
a first surface facing the light emitting device and including a recessed portion, the recessed portion having a symmetrical structure with respect to an optical axis passing through a center of the optical device and having a flat top surface, a top portion of the recess being a planar portion,
a second surface opposite to the first surface and having a concave portion, the concave portion having a symmetrical structure with respect to the optical axis, and
the recess recessed toward the second surface and the concave portion depressed toward the planar portion of the recess.

17. The light source structure of claim 16, wherein the recess further includes a curved side surface, the curved side portion intersects with the planar portion at a point, and an angle formed by the optical axis and a straight line is about 10°, the straight line being a line of the emitted light drawn to the point.

18. The light source structure of claim 17, wherein the second surface is configured to increase a value of θ₂/θ₁ in accordance with an increase in a first angle θ1 within a range of less than 10° and decrease the value of θ₂/θ₁ in accordance with an increase in the first angle θ1 within a range of about equal to or greater than 10°, where a first angle θ₁ indicates an angle of the emitted light with respect to the optical axis and a second angle θ₂ indicates an angle at which the emitted light is outwardly irradiated from the second surface.

19. The light source structure of claim 16, wherein the second surface protrudes in a dome shape from an edge of the first surface.

20. The light source structure of claim 16, wherein the first surface has a curved surface downwardly protruding toward the light emitting device.
